(19) United States
(12) Patent Application Publication
(10) Pub. No.: US 2011/0320466 A1
(43) Pub. Date: Dec. 29, 2011

(54) METHODS AND SYSTEMS FOR FILTERING SEARCH RESULTS

(76) Inventors: ODED BROSHI, Bar Giora (IL); Arik Kopelman, Hod Hasharon (IL)

(21) Appl. No.: 13/168,194

(22) Filed: Jun. 24, 2011

Related U.S. Application Data
(60) Provisional application No. 61/358,084, filed on Jun. 24, 2010.

(51) Int. Cl. G06F 17/30

(52) U.S. Cl. 707/754; 707/E17.014

(57) ABSTRACT

Methods and systems of filtering search results are presented. The filtering may comprise receiving a search query term having a plurality of meanings in a search language; selecting a resolving language including a plurality of resolving language terms, wherein each resolving language term corresponds to one meaning or a related set of meanings of the plurality of meanings of the search query term; identifying a plurality of hits stored on a data source, wherein each hit is a data object associated with one of the resolving language terms; displaying at least two of the plurality of hits; receiving a selection of one of the displayed hits; and displaying one or more of the plurality of hits associated with the same resolving language term as the resolving language term associated with the selected hit.

### CROSS-REFERENCE TO RELATED APPLICATIONS

This application is based on and derives the benefit of the filing date of U.S. Provisional Patent Application No. 61/358,084, filed Jun. 24, 2010. The entire content of this application is herein incorporated by reference in its entirety.

### BRIEF DESCRIPTION OF THE DRAWINGS

FIG. 1 is an example block diagram of a system for filtering search results according to an embodiment of the present invention.

FIG. 2 is a flowchart for an example process for filtering search results according to an embodiment of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Embodiments of the invention may comprise one or more computers. A computer may be any programmable machine capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, and other terms. It will be understood by those of ordinary skill that those terms used herein are interchangeable, and any computer capable of performing the described functions may be used. For example, though the term “server” may appear in the following specification, the disclosed embodiments are not limited to servers. The term server may refer to a single server or to a functionally associated cluster of servers. Unless specifically stated otherwise, as apparent from the following discussions, it is appreciated that throughout the specification discussions utilizing terms such as “processing”, “computing”, “calculating”, “determining”, or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computer selectively activated or reconfigured by a computer program stored in the computer. Such a computer program may be stored in a computer readable storage medium, including but not limited to any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions and capable of being coupled to a computer system bus. The processes and displays presented herein may not be inherently related to any particular computer or other apparatus. Various general purpose systems may be used with programs in accordance with the teachings herein, or it may prove convenient to construct a more specialized apparatus to perform the desired method. It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

Suitable structures for a variety of these systems may appear in or be apparent from the description below. In addition, embodiments of the present invention are not described with reference to any particular programming language. It will be appreciated that a variety of programming languages may be used to implement the teachings of the inventions as described herein.

It should be understood that any topology, technology and/or standard for computer networking (e.g. mesh networks, infiniband connections, RDMA, etc.), known today or to be devised in the future, may be applicable to the present invention.

The present invention may provide methods, circuits, and/or systems for filtering digital content search results, for example search results provided by a search engine. Search engines may be software applications that may be adapted to search digital content and locate content that may meet pre-defined criteria. A search engine may be an information retrieval system for information stored in digital form. Search results may be presented in a list and may be called hits. An example of a search engine is a web search engine which may search for information on the World Wide Web.

Search engines may provide an interface to a group of items that may enable users to specify criteria about an item of interest and have the engine find matching items. The criteria may be referred to as a search query. In the case of text search engines, the search query may be expressed as a set of words that identify the desired concept that one or more documents may contain. There may be several styles of search query syntax that may vary in strictness. For example, some text search engines may require users to enter two or three words separated by white space, and other search engines may enable users to specify entire documents, pictures, sounds, and various forms of natural language. Some search engines may apply improvements to search queries to increase the likelihood of providing a quality set of items through a process known as query expansion. The list of items that meet the criteria specified by the query may be sorted or ranked, for example by relevance, date updated, and/or on some other basis. Probabilistic search engines may rank items based on measures of similarity (between each item and the query, for example on a scale of 1 to 0, 1 being most similar) and/or based on popularity, authority, or relevance feedback. Boolean search engines may return items which match exactly without regard to order, although the term boolean search engine may simply refer to the use of boolean-style syntax (the use of operators AND, OR, NOT, and XOR) in a probabilistic context.

To provide a set of matching items sorted according to some criteria, a search engine may collect metadata about the group of items under consideration beforehand through a process referred to as indexing. Some search engines may only store the indexed information and not the full content of each item, and may provide a method of navigating to the full items in a search engine result page. Alternatively, the search engine may store a copy of each item in a cache so that users can see the state of the item at the time it was indexed.

Other types of search engines may not store an index. Crawler or spider type search engines (a.k.a. real-time search engines) may collect and assess items at the time of the search query, and may dynamically consider additional items based on the contents of a starting item (known as a seed, or seed URL in the case of an Internet crawler). Meta search engines may store neither an index nor a cache and instead may reuse the index or results of one or more other search engines to provide an aggregated set of results.

In some embodiments of the present invention, results of a search query including an ambiguous query term (i.e. a term having more than one meaning) in a source language (i.e. the language in which the search is originally performed) may be filtered based on a second query term in a second language (the “resolving language”), which second query term represents a meaning of the original ambiguous query term. In some embodiments, the second query term may represent a set of related meanings of the original ambiguous query term (e.g. the second query term may have a meaning that corresponds to more than one meaning of the original term, but these multiple meanings may be closely enough related to yield similar search results). In some embodiments of the present invention, for said filtering a second query term may be selected which may be determined to best represent an estimated intended meaning of the original query term. A second query term best representing an estimated intended meaning of an ambiguous query term may be resolved or determined by:

(1) translating the ambiguous query term into two or more second query terms in a resolving language selected from a group of available resolving languages, based on:

(i) the number of different terms in the resolving language that represent a meaning of the ambiguous query term (i.e. selecting a resolving language in which as many different meanings of the ambiguous query term as possible are represented by different terms in the resolving language, which may indicate less ambiguity in the relevant terms in the resolving language);

(ii) the practicality of filtering the search results based on a term in the resolving language (i.e. selecting a resolving language in which relevant query terms are more easily associated with specific digital content within the search results. For example, if the search being conducted is for images and there are significantly more images tagged in German than in Swahili, German may be preferred to Swahili as a resolving language for this search); and/or

(iii) any other relevant criteria.

(2) presenting to a user two or more digital contents (e.g. images), each of which may be associated with the original query term and one of the second query terms in a resolving language.

(3) recording, registering or otherwise noting a selection of the user made from the digital contents presented.

(4) determining/resolving that a second query term representing the estimated intended meaning of the original ambiguous query term may be the second query term associated with the specific digital content selected by the user.

Once the second query term best representing the estimated intended meaning is determined/resolved, the search results relating to the original ambiguous query term may be filtered based on the second query term determined to best represent the estimated intended meaning (i.e. the second query term associated with the specific digital content selected by the user). Filtering search results may comprise removing digital contents which do not meet the filtering criteria from the list, of digital contents associated with an original query term. For example, the filtering criteria may be that the contents are not associated with the second query term.

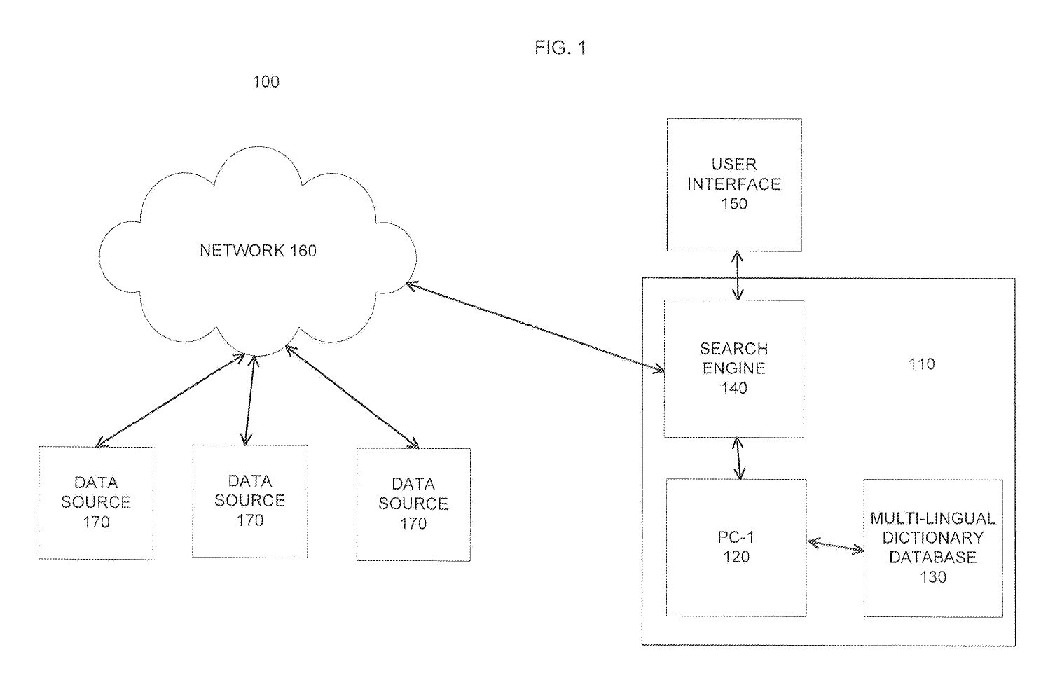

FIG. 1 is an example block diagram of a system 100 which may be used for filtering search results according to an embodiment of the present invention. The system 100 may comprise at least one server 110 which may include at least one processor 120 (hereby: “LM-1”) functionally associated with at least one digital content search application 140, such as a web search engine (hereby: “the search engine”); and at least one database 130 functionally associated with the LM-1 containing one or more multi-lingual dictionaries. In some embodiments the search engine 140 may run on the server 110, and in some other embodiments the server 110 may direct the operations of a search engine 140 running on a different computer through a network connection or other suitable channel. The computer running the search engine 140 may be connected to at least one network 160, and the search engine 140 may search data stored on one or more data source computers 170 which may also be connected to the network 160. A user interface 150 may be functionally associated with the search engine. The user interface 150 may be embodied in software running on the server 110 or may be part of a remote system such as a personal computer which may communicate with the server 110 through a network or other communication channel.

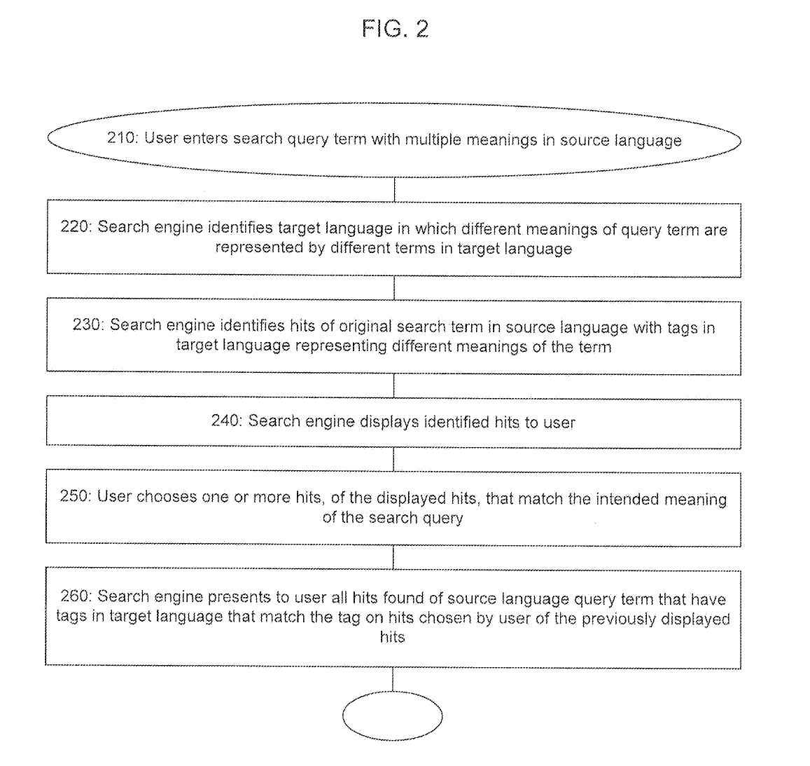

FIG. 2 is a flowchart for an example process for filtering search results according to an embodiment of the present invention. The process of FIG. 2 will be presented in the context of the system of FIG. 1 in the following example, although it may be performed by other systems. The LM-1 120 may be adapted to detect when a user enters a search query 210 into the search engine 140 that is ambiguous in the language used by the user (the “source language”). For example the word “wood” in English may refer to the material wood, such as is used to construct houses, or may refer to a group of trees. In the event that the LM-1 120 detects such a term, the LM-1 120 may be adapted to identify one or more other languages in which different meanings of the term in the source language are represented by different words. The LM-1 120 may also be adapted to retrieve 220 from the database 130 multiple terms in the identified languages (the “resolving languages” or “target languages”) each of which may represent a different meaning of the term in the source language. In this example, the LM-1 120 may retrieve, for example, the terms “holtz” and “wald” in German, which respectively represent the two meanings of the term “wood” presented above. In some embodiments the LM-1 120 may give priority to resolving languages that have more terms representing different meanings of the term being translated.

In some embodiments, the LM-1 120 may be adapted to retrieve 220, substantially simultaneously or subsequentially, terms in multiple languages meeting the same criteria, i.e. representing different meanings of the source language term. Returning to the above example, the LM-1 120 may, for example, also be adapted to retrieve the terms “madera” and “bosque” in Spanish, which respectively represent the two meanings of the term “wood” presented above.

The LM-1 120 may be further adapted to then cause the search engine 140 to identify hits 230 associated with the source language query term that may also be associated with terms identified as representing different meanings of the source language query term in a resolving language. “Hits” 230 may be digital content or data files associated with a query term. The data files may be any type of media file that can be searched using associated text, such as images, music or other audio files, and/or video files. Returning to the above example, the LM-1 120 may be further adapted to cause the search engine 140 to identify hits associated with the term “wood” in English and also associated with: (1) either the term “holtz” or “wald” in German; and/or (2) either the term “madera” or “bosque” in Spanish.

The LM-1 120 may be yet further adapted to then cause the search engine 140 to display 240 through the user interface 150 two or more hits identified as being associated with the user entered source language query term and as being associated with different terms in a resolving language. The LM-1 120 may be adapted to receive 250 a user's selection made among the displayed hits. Based on a user selection from the hits displayed made through the user interface 150, the LM-1 120 may be further adapted to then cause the search engine 140 to filter the search results associated with the user entered source language query term, so that only hits also associated with the resolving language query term associated with the user's previous selection may be presented through the user interface 150. Again returning to the above example, the LM-1 120 may, for example, be further adapted to cause the search engine 140 to display through the user interface 150 one hit identified as associated with “wood” and “holtz” (e.g. an image of a mahogany board) and one hit associated with “wood” and “wald” (e.g. an image of Sherwood forest). If the user selects the first of the two through the user interface 150, the LM-1 120 may be adapted to then cause the search engine 140 to present 260 to the user through the user interface 150 only hits associated with “wood” and “holtz” (e.g. images associated with the material wood), whereas if the user selects the second of the two, only hits associated with “wood” and “wald” may be presented (e.g. images of forests).

In order to filter search results based on a second query term, different digital contents within the search results may be associated with different second query terms in a resolving language. This association may be achieved:

(1) Directly, when digital contents include or are associated with data (i.e. embedded text or metadata) in the resolving language, for example if the digital content is “tagged” with a term in the resolving language. In this case, digital contents may be associated with a query term in a resolving language when that term appears in data included or associated with the digital content.

(2) Indirectly, for example by using a translation engine that may have contextual translation abilities to translate content (i.e. embedded text or metadata) included in or associated with the digital content into the resolving language, and then associating digital content with a query term in the resolving language when the translation includes that term.

It should be understood that although search results may be filtered in a second language (e.g. resolving language), the filtered results may be presented to a user in either the original/source language used for the search, or in any other language to which the results may be translated by a machine translation system.

It should be understood by one of skill in the art that some of the functions described as being performed by a specific component of the system may be performed by a different component or the system in other embodiments of this invention.

Embodiments of the present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. It should be recognized, however, that the present invention might be practiced without resorting to the details specifically set forth. In the description and claims of embodiments of the present invention, each of the words, “comprise” “include” and “have”, and forms thereof, are not necessarily limited to members in a list with which the words may be associated.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages are presented for example purposes only. The disclosed methodology and system are each sufficiently flexible and configurable such that they may be utilized in ways other than those shown.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

It should also be noted that the terms “a”, “an”, “the”, “said”, etc. signify “at least one” or “the at least one” in the specification, claims and drawings.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A method of filtering search results comprising:
receiving a search query term having a plurality of meanings in a search language with a computer;
selecting a resolving language including a plurality of resolving language terms with the computer, wherein each resolving language term corresponds to one meaning or a set of related meanings of the plurality of meanings of the search query term;
identifying a plurality of hits stored on a data source connected to the computer through a network with the computer, wherein each hit is a data object associated with one of the resolving language terms;
displaying at least two of the plurality of hits with the computer;
receiving a selection of one of the displayed hits with the computer; and
displaying one or more of the plurality of hits associated with the same resolving language term as the resolving language term associated with the selected hit.

2. The method of claim 1, wherein the resolving language is selected from a plurality of possible languages based on a number of resolving language terms available in each of the plurality of possible languages.

3. The method of claim 1, wherein the resolving language is selected from a plurality of possible languages based on a total number of possible hits associated with the plurality of resolving language terms.

4. The method of claim 1, wherein the plurality of hits are image files, audio files, and/or video files.

5. The method of claim 1, wherein the one or more associated hits are displayed in the search language.

6. The method of claim 1, wherein the one or more associated hits are displayed in the resolving language.

7. The method of claim 1, wherein the one or more associated hits are displayed as image files, audio files, and/or video files.

8. The method of claim 1, wherein the association between each hit and resolving language term is formed by detecting the resolving language term in a piece of metadata or embedded text associated with the hit.

9. The method of claim 1, wherein the association between each hit and resolving language term is formed by:
translating a piece of metadata or embedded text associated with the hit into the resolving language; and
detecting the resolving language term in the translated piece of metadata or embedded text.

10. A system for filtering search results comprising:
a computer constructed and arranged to:
communicate with a network;
receive a search query term having a plurality of meanings in a search language;
select a resolving language including a plurality of resolving language terms, wherein each resolving language term corresponds to one meaning or a set of related meanings of the plurality of meanings of the search query term;
identify a plurality of hits stored on one or more data sources connected to the network, wherein each hit is a data object associated with one of the resolving language terms;
display at least two of the plurality of hits;
receive a selection of one of the displayed hits; and
display one or more of the plurality of hits associated with the same resolving language term as the resolving language term associated with the selected hit.

11. The system of claim 10, wherein the computer is further constructed and arranged to select the resolving language from a plurality of possible languages based on a number of resolving language terms available in each of the plurality of possible languages.

12. The system of claim 10, wherein the computer is further constructed and arranged to select the resolving language from a plurality of possible languages based on a total number of possible hits associated with the plurality of resolving language terms.

13. The system of claim 10, wherein the plurality of hits are image files, audio files, and/or video files.

14. The system of claim 10, wherein the one or more associated hits are displayed in the search language.

15. The system of claim 10, wherein the one or more associated hits are displayed in the resolving language.

16. The system of claim 10, wherein the one or more associated hits are displayed as image files, audio files, and/or video files.

17. The system of claim 10, wherein the at least computer is further constructed and arranged to form the association between each hit and resolving language term by detecting the resolving language term in a piece of metadata or embedded text associated with the hit.

18. The system of claim 10, wherein the at least computer is further constructed and arranged to form the association between each hit and resolving language term by:
translating a piece of metadata or embedded text associated with the hit into the resolving language; and
detecting the resolving language term in the translated piece of metadata or embedded text.
